(19) United States
(12) Patent Application Publication
(10) Pub. No.: US 2016/0189037 A1
(43) Pub. Date: Jun. 30, 2016

(54) HYBRID TECHNIQUE FOR SENTIMENT ANALYSIS

(71) Applicant: Intel Corporation, Santa Clara, CA (US)

(72) Inventors: Oren Pereg, Amikam (IL); Moshe Wasserblat, Maccabim (IL); Michel Assayag, Shoham (IL); Alexander Sivak, Haifa (IL); Saurav Sahay, Santa Clara, CA (US); Junaith Ahemed Shahabdeen, San Jose, CA (US)

(73) Assignee: Intel Corporation, Santa Clara, CA (US)

(21) Appl. No.: 14/582,235

(22) Filed: Dec. 24, 2014

(51) Int. Cl. G06N 5/04; G06N 7/00; G06N 99/00

(52) U.S. Cl. CPC G06N 5/04; G06N 99/005; G06N 7/005

(57) ABSTRACT

One embodiment provides an apparatus. The apparatus includes a processor; at least one peripheral device coupled to the processor; a memory coupled to the processor; a generic sentiment model and a first domain training corpus stored in memory; and a hybrid sentiment analyzer logic stored in memory and to execute on the processor. The hybrid sentiment analyzer logic includes a sentiment lexicon generator logic to generate a domain sentiment lexicon based, at least in part, on the first domain training corpus and to store the domain sentiment lexicon in memory, a lexicon-based sentiment classifier logic to generate an annotated training corpus unsupervisedly, based, at least in part, on the domain sentiment lexicon and to store the annotated training corpus in memory, and a model-based sentiment adaptor logic to adapt the generic sentiment model based, at least in part, on the annotated training corpus to generate an adapted sentiment model and to store the adapted sentiment model in memory.

### FIELD

The present disclosure relates to sentiment analysis, in particular to, a hybrid technique for sentiment analysis.

### BACKGROUND

Sentiment analysis is configured to identify and extract subjective information, such as attitudes and/or opinions from textual documents. Automated identification of sentiment terms that convey positive, negative or neutral opinions and/or attitudes can be challenging. Whether a sentiment term is positive, negative (or neutral) may depend on, for example, a topical domain and/or an element in the domain. For example, “unpredictable” may be positive with respect to a movie (e.g., a movie review domain) and may be negative with respect to financial markets (e.g., a financial market analysis domain). In another example, “large” may be positive with respect to a screen size and negative with respect to a battery size (e.g., a tablet computer domain).

### BRIEF DESCRIPTION OF DRAWINGS

Features and advantages of the claimed subject matter will be apparent from the following detailed description of embodiments consistent therewith, which description should be considered with reference to the accompanying drawings, wherein:

FIG. 1 illustrates a functional block diagram of a sentiment analysis system consistent with various embodiments of the present disclosure;

FIG. 2 is a flowchart of adapted sentiment model generation operations according to various embodiments of the present disclosure; and

FIG. 3 is a flowchart of testing corpus classification operations using the adapted sentiment model of FIG. 2 according to various embodiments of the present disclosure.

Although the following Detailed Description will proceed with reference being made to illustrative embodiments, many alternatives, modifications, and variations thereof will be apparent to those skilled in the art.

### DETAILED DESCRIPTION

Generally, this disclosure relates to hybrid method(s) and system(s) for sentiment analysis. The methods and systems are configured to generate a domain-specific sentiment lexicon and an annotated training corpus in an unsupervised manner, i.e., unsupervisedly. The methods and systems are further configured to adapt a generic sentiment model in a supervised manner, i.e., supervisedly, using the unsupervisedly generated annotated training corpus to provide a domain-specific adapted sentiment model. The domain-specific adapted sentiment model may then be used to classify a sentiment of a testing corpus.

Unsupervised generation of the domain-specific sentiment lexicon and annotated training corpus are configured to avoid manually annotating (i.e., tagging) a lexicon and/or training corpus for each domain of a plurality of domains. Adapting the generic sentiment model, supervisedly, using the supervisedly generated annotated training corpus is configured to provide a relatively better classification accuracy compared to unsupervised classification accuracy. Together, the unsupervised and supervised (i.e., hybrid) operations are configured to support domain-specific classification of a testing corpus while avoiding the labor associated with manually annotating a plurality of domain-specific training corpora with respective sentiment polarities.

As used herein, a sentiment lexicon is a collection of sentiment terms and their associated sentiment polarities. Sentiment polarities include, but are not limited to, positive, negative and neutral. As used herein, a sentiment term is a word and/or phrase that conveys a sentiment, e.g., an opinion and/or an attitude. As used herein, a corpus is a collection of corpus elements. Corpus elements include textual words, phrases, sentences and/or documents. As used herein, “textual” corresponds to text format. The textual words, phrases, sentences and/or documents may be related to textual information. Textual information may include, but is not limited to, emails, text messages (e.g., associated with social media), transcribed telephone conversations and/or consumer reviews acquired from forums, product websites, seller/reseller websites and/or review websites, etc. An annotated corpus includes a collection of corpus elements annotated with their associated sentiment polarities. A domain training corpus is a collection of corpus elements related to a specific sentiment domain. As used herein, a sentiment domain includes a topical domain, a user domain and/or a group domain. A topical domain is related to a topic, concept, person, organization, location, thing, entity, etc., about which a sentiment may be expressed. For example, topical domains may include, but are not limited to, sports, weather, movie reviews, consumer products (e.g., consumer electronics), transportation, etc. A user domain is related to sentiment, e.g., attitudes and/or opinions expressed by a specific user. A group domain is related to sentiments expressed by a specific group of related users. For example, the group of users may have a common employer, a common work location and/or a common work group, may share common demographics (e.g., education, income, socioeconomic status, age, etc.) and/or may reside in a common geographic region.

As used herein, unsupervised corresponds to annotation and/or classification techniques that do not utilize training examples and/or models. Unsupervised operations are typically configured to detect sentiment terms using rules and without being trained using training examples. As used herein, supervised corresponds to annotation and/or classification techniques that utilize training examples and/or models. The training examples may support generation and/or modification of the model (“training”). The training examples may further support evaluating accuracy of a model based, at least in part, on the classification result. Classification (i.e., classifying) corresponds to determining whether a sentiment associated with a testing corpus (and/or testing corpus element) is positive, negative or neutral. A testing corpus may include one or more word(s), phrase(s), sentence(s) and/or document(s), i.e., may include one or more corpus element(s). The testing corpus may be related to a specific domain.

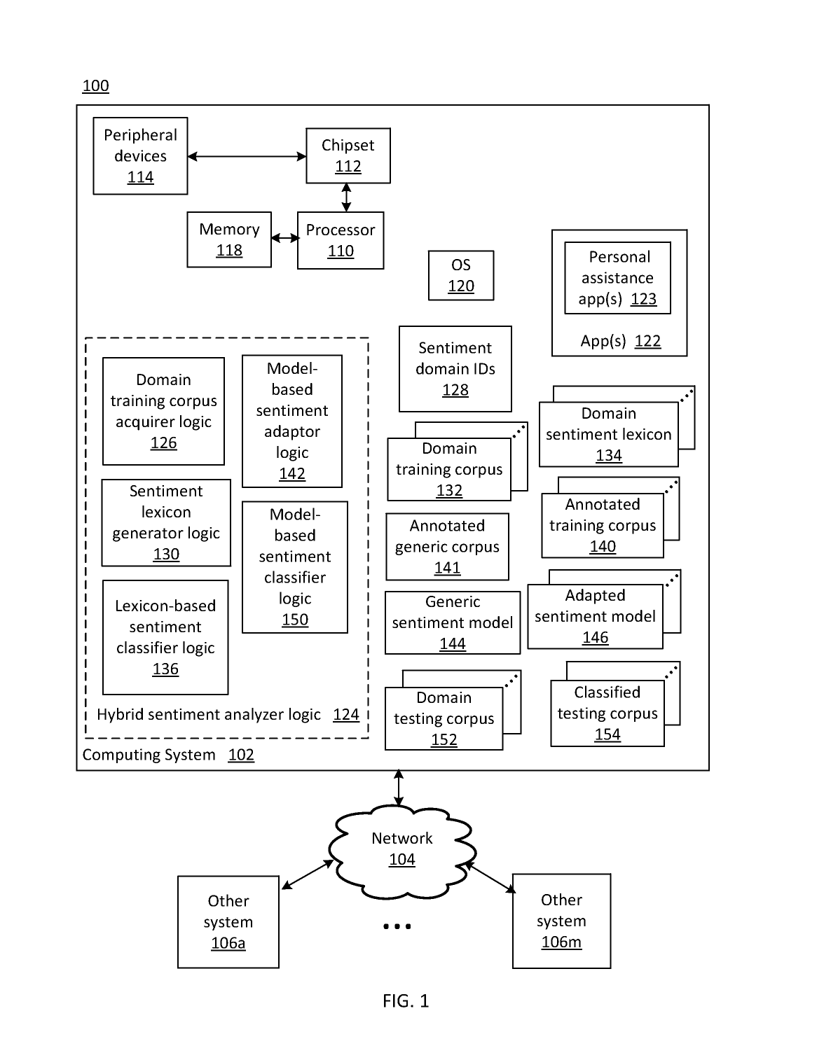

FIG. 1 illustrates a system block diagram of a sentiment analysis system 100 consistent with several embodiments of the present disclosure. Sentiment analysis system 100 includes a computing system 102, network 104 and a plurality of other systems 106a, . . . , 106m. Computing system 102 may include, but is not limited to, a server, a workstation computer, a desktop computer, a laptop computer, a tablet computer (e.g., iPad®, GalaxyTab® and the like), an ultraportable computer, an ultramobile computer, a netbook computer and/or a subnotebook computer; a mobile telephone including, but not limited to a smart phone, (e.g., iPhone®, Android®-based phone, Blackberry®, Symbian®-based phone, Palm®-based phone, etc.) and/or a feature phone; and/or wearable device and/or system.

Computing system 102 includes a processor 110, a chipset 112, peripheral devices 114 and memory 118. Processor 110 is configured to perform operations of computing system 102 and may include one or more core(s). Chipset 112 is configured to couple processor 110 to peripheral devices 114. For example, chipset 112 may include a peripheral controller hub (PCH). In another example, chipset 112 may include a sensors hub. Peripheral devices 108 may include, for example, user interface device(s) including a display, a touch-screen display, printer, keypad, keyboard, etc., sensor(s) including accelerometer, global positioning system (GPS), gyroscope, etc., communication logic including wired and/or wireless communication logic and/or input/output (I/O) port(s), storage device(s) including hard disk drives, solid-state drives, removable storage media, etc.

Computing system 102 includes an operating system (OS) 120 and may include one or more application(s) App(s) 122. The OS 120 is configured to manage operations of computing system 102. The App(s) 122 may be configured to perform operations based, at least in part, on user inputs received on one or more of peripheral device(s) 114. The App(s) 122 may be configured to provide result(s) of the operations on one or more of peripheral device(s) 114. Processor 110 may be configured to execute one or more of App(s) 122.

For example, App(s) 122 may include one or more personal assistance app(s) 123. A personal assistance app may be configured to recognize a user sentiment and to make a recommendation to the user based, at least in part, on the recognized user sentiment. For example, based, at least in part, on user sentiment(s) related to a restaurant and/or type(s) of food, the personal assistance app 123 may be configured to provide the user a personalized restaurant recommendation. The user sentiment(s) may be determined based on textual information and sentiment analyses results produced as described herein. For example, the result(s) may be included in classified testing corpus 154.

Computing system 102 includes hybrid sentiment analyzer logic 124. Computing system 102 may include sentiment domain identifier(s) (ID(s)) 128, one or more domain training corpora, e.g., domain training corpus 132 and one or more domain sentiment lexicon(s), e.g., domain sentiment lexicon 134. Hybrid sentiment analyzer logic 124 may include domain training corpus acquirer logic 126, sentiment lexicon generator logic 130 and/or lexicon-based sentiment classifier logic 136. A sentiment domain ID is configured to identify a sentiment domain. The sentiment domain ID may be included in sentiment domain ID(s) 128. A sentiment domain may be selected by selecting an associated sentiment domain ID from sentiment domain ID(s) 128. For example, a user may select a sentiment domain ID. In another example, App(s) 122, e.g., personal assistance app 123, may be configured to select a sentiment domain ID. Sentiment domains may include, but are not limited to, sports, weather, movie reviews, consumer products (e.g., consumer electronics), transportation, etc.

Domain training corpus acquirer logic 126 is configured to acquire a domain training corpus 132. The domain training corpus 132 may be associated with the selected, i.e., specific, sentiment domain. The sentiment domain may include one or more of a topical domain, a user domain and/or a group domain. The domain training corpus 132 may be extracted from acquired textual information. Textual information may be acquired from one or more of peripheral device(s) 114, network 104 and/or other system(s) 106a, . . . , 106m.

For example, at least a portion of domain training corpus 132 may be acquired by domain training corpus acquirer logic 126 from one or more other systems(s) 106a, . . . , 106m via network 104. In another example, at least a portion of domain training corpus 132 may be captured by domain training corpus acquirer logic 126 from one or more of peripheral device(s) 114, e.g., keypad, touchscreen, etc. Thus, domain training corpus 132 may be acquired from interactions between a user of computing system 102 and a partner, e.g., may include a message, and/or may be acquired from one or more websites via network 104. The websites may be hosted by one or more other system(s) 106a, . . . , 106m.

The selected sentiment domain may correspond to a topical domain, a user domain and/or a group domain, as described herein. For example, for a selected sentiment domain that corresponds to a topical domain, the domain training corpus 132 may be acquired from websites, including product review websites and/or online sellers/resellers. In another example, for a selected sentiment domain that corresponds to a user domain, the domain training corpus 132, e.g., transmitted instant messages, transmitted text messages related to social media, etc., may be captured from peripheral device(s) 114. Thus, in this example, the domain training corpus 132 may include textual information generated and transmitted by the user. In another example, for a selected sentiment domain that corresponds to a group domain, the domain training corpus 132 may include textual information communicated between a selected group of users. One user may be using computing system 102 and other user(s) may be using respective other system(s) 106a, . . . , 106m. The domain training corpus 132 may thus include a plurality of words, phrases, sentences and/or documents (i.e., corpus elements) related to the selected sentiment domain.

The domain sentiment lexicon 134 may be generated, unsupervisedly, based, at least in part, on the domain training corpus 132. For example, sentiment lexicon generator logic 130 may be configured to generate the domain sentiment lexicon 134. The domain training corpus 132 may include words, phrases, sentences and/or documents that include sentiment term(s). Sentiment lexicon generator logic 130 is configured to identify and extract sentiment term(s) and their associated sentiment polarities from the domain training corpus 132. The extracted sentiment term(s) and their associated sentiment polarities may then be stored in domain sentiment lexicon 134.

For example, sentiment lexicon generator logic 130 may include a set of rules that utilize a dependency parser configured to identify known sentiment terms, detect words related to the known sentiment terms and to use the relationships between the known sentiment terms and the detected words to identify new sentiment terms and their associated polarities. Initially, the known sentiment terms may include generic sentiment terms whose associated polarity is independent of domain. For example, “great”, “good”, “bad” and “poor” are generic sentiment terms whose respective polarities are domain-independent. The dependency parser may be configured to operate in an iterative manner. For example, for each iteration, the sentiment lexicon generator logic 130 may be configured to detect words related to the known sentiment terms and words related to sentiment terms identified in earlier iterations. For example, some relationships may be identified by a conjunctive, e.g., “and”, “but”. Sentiment terms related by the conjunctive “and” may have the same sentiment polarity. Sentiment terms related by the conjunctive “but” may have opposite sentiment polarities.

Thus, domain sentiment lexicon 134 may be generated, unsupervisedly, for a specific domain based, at least in part, on the domain training corpus 132. Domain sentiment lexicon 134 is configured to include generic sentiment terms and domain-specific sentiment terms. A plurality of domain sentiment lexicons, e.g., domain sentiment lexicon 134, may be generated for the plurality of sentiment domains.

Computing system 102 may further include one or more annotated training corpora, e.g., annotated training corpus 140, an annotated generic corpus 141, a generic sentiment model 144 and one or more adapted sentiment model(s), e.g., adapted sentiment model 146. Hybrid sentiment analyzer logic 124 may further include model-based sentiment adaptor logic 142. Annotated training corpus 140 may be generated unsupervisedly based, at least in part, on sentiment term(s) included in domain sentiment lexicon 134. For example, lexicon-based sentiment classifier logic 136 may be configured to search each phrase, sentence and/or document (i.e., corpus element) included in domain training corpus 132 to detect the sentiment term(s). Sentiment term(s) may include generic sentiment terms and domain-specific sentiment term(s). Each corpus element may be analyzed and associated detected sentiment terms may be accumulated for the corpus element. A positive sentiment term may correspond to a positive one (+1), a negative sentiment term may correspond to a negative one (−1) and a neutral sentiment term may correspond to zero (0). For example, beginning with an initial value of zero, a sum may be incremented for each detected positive sentiment term, decremented for each detected negative sentiment term and unchanged for each neutral sentiment term. A result for each corpus element may then correspond to the sentiment associated with the corpus element. For example, a positive result may correspond to a positive sentiment, a negative result may correspond to a negative sentiment and a zero result may correspond to a neutral sentiment.

Lexicon-based sentiment classifier logic 136 is then configured to associate (i.e., annotate) each corpus element with the determined sentiment polarity. The corpus element and associated sentiment polarity may then be stored in annotated training corpus 140. Thus, annotated training corpus 140 may include a plurality of training examples with each example including a corpus element and associated polarity. The training examples, i.e., annotated training corpus 140, associated with the selected sentiment domain, may be generated unsupervisedly, as described herein.

In an embodiment, the corpus elements of domain training corpus 132 used to generate the domain sentiment lexicon 134 may be annotated to generate the annotated training corpus 140. In an embodiment, different corpus elements of domain training corpus 132 may be annotated to generate the annotated training corpus 140. For example, lexicon-based sentiment classifier logic 136 may be configured to generate the annotated training corpus 140 based, at least in part, on a domain-specific corpus different from domain training corpus 132. In other words, a first domain training corpus may be used to generate domain sentiment lexicon 134 and a second domain training corpus may be used to generate the annotated training corpus 140. In both embodiments, the corpus elements may be associated with the selected sentiment domain.

Adapted sentiment model 146 may be generated (i.e., adapted) based, at least in part, on the annotated training corpus 140 and based, at least in part, on a generic sentiment model 144. The generic sentiment model 144 may be generated and/or acquired by hybrid sentiment analyzer logic 124. The generic sentiment model 144 is general, i.e., may not correspond to a specific domain. For example, the generic sentiment model 144 may be acquired from one or more other system(s) 106a, . . . , 106m. In another example, the generic sentiment model 144 may be generated based, at least in part, on a manually tagged (i.e., annotated) generic corpus 141. The annotated generic corpus 141 may not correspond to a specific sentiment domain. The annotated generic corpus 141 may be considered a general corpus that may be used for any sentiment domain. The generic sentiment model 144 may be produced supervisedly. For example, the generic sentiment model 144 may be generated using a support vector machine (SVM). In another example, the generic sentiment model 144 may be generated using an updatable Naïve Bayes model. In another example, the generic sentiment model 144 may be generated using an artificial neural network (ANN).

The adapted sentiment model 146 may be adapted by model-based sentiment adaptor logic 142. Model-based sentiment adaptor logic 142 is configured to receive the generic sentiment model 144 and the annotated training corpus 140 and to adapt (e.g., train) the generic sentiment model 144 based, at least in part, on the annotated training corpus 140 to produce a sentiment model adapted to the selected domain. The annotated training corpus 140 may thus correspond to a set of domain-specific training examples that are provided to adapt the generic sentiment model 144. The set of training examples, i.e., the annotated training corpus 140, may be generated unsupervisedly, for each selected sentiment domain, as described herein. The adapted sentiment model 146 may be produced supervisedly. Adaptation of the generic sentiment model 144 may be performed, for example, using a support vector machine (SVM). In another example, the generic sentiment model 144 may be adapted using an updatable Naïve Bayes model. In another example, the generic sentiment model 144 may be adapted using an artificial neural network (ANN).

In one example, both the annotated generic corpus 141 and the annotated training corpus 140 may be provided to the model-based sentiment adaptor logic 142 as training examples. In this example, a relative portion of training examples may be managed such that 80 percent (%) of the training examples originate from the annotated generic corpus 141 and 20% of the training examples originate from the annotated training corpus 140. In another example, only the annotated training corpus 140 may be provided to the model-based sentiment adaptor logic 142 as training examples. Thus, the adapted sentiment model 146 may be produced, supervisedly, based, at least in part, on the annotated training corpus 140.

Thus, a domain training corpus may be acquired for a selected domain, a domain sentiment lexicon may be generated unsupervisedly and an annotated training corpus may be unsupervisedly generated. The annotated training corpus may then correspond to training examples utilized to adapt a generic sentiment model to the selected sentiment domain, supervisedly. The adapted sentiment model may then be utilized to classify one or more corpus element(s) of a testing corpus.

Computing system 102 may include one or more domain testing corpora, e.g., domain testing corpus 152 and one or more classified testing corpora, e.g., classified testing corpus 154. Hybrid sentiment analyzer logic 124 may further include model-based sentiment classifier logic 150. Model-based sentiment classifier logic 150 is configured to receive the domain testing corpus 152 and to select an adapted sentiment model. The domain testing corpus 152 includes a collection of testing corpus elements, i.e., a collection of words, phrases, sentences and/or documents related to a sentiment domain that are to be classified. The collection of testing corpus elements may be extracted from textual information. Classification (i.e., classifying) includes labeling the corpus elements with respective sentiment polarities, i.e., positive, negative or neutral based, at least in part, on the adapted sentiment model 146. The sentiment domain(s) associated with the domain testing corpus 152 may be determined and/or identified. For example, model-based sentiment classifier logic 150 may be configured to analyze the domain testing corpus 152 to determine the associated sentiment domain. In another example, the sentiment domain may be selected and/or specified by a user via peripheral device(s) 114.

The model-based classifier logic 150 may be configured to select an adapted sentiment model, e.g., adapted sentiment model 146, based, at least in part, on the identified sentiment domain. For example, computing system 102 may include a plurality of adapted sentiment models, e.g., adapted sentiment model 146, and each adapted sentiment model may correspond to a respective sentiment domain.

Model-based classifier logic 150 may then be configured to classify the domain testing corpus 152 using the adapted sentiment model 146. Model-based classifier logic 150 may use a classifier that is based on an SVM model, an updatable Naïve Bayes model, an ANN model, etc. Model-based classifier logic 150 may then be configured to provide a classified testing corpus 154 as output to, e.g., a user. The classified testing corpus 154 may include each corpus element of the domain testing corpus 152 annotated (i.e., classified) with a respective sentiment polarity.

Thus, methods and systems consistent with the present disclosure are configured to generate a domain specific sentiment lexicon and an annotated training corpus, unsupervisedly for a selected domain. The methods and systems are further configured to adapt a generic sentiment model using the annotated training corpus to provide a domain-specific adapted sentiment model, supervisedly. The hybrid approach is configured to avoid manually tagging (annotating) sentiment lexicons and/or domain training corpora for a plurality of domains while providing the accuracy of supervised classification.

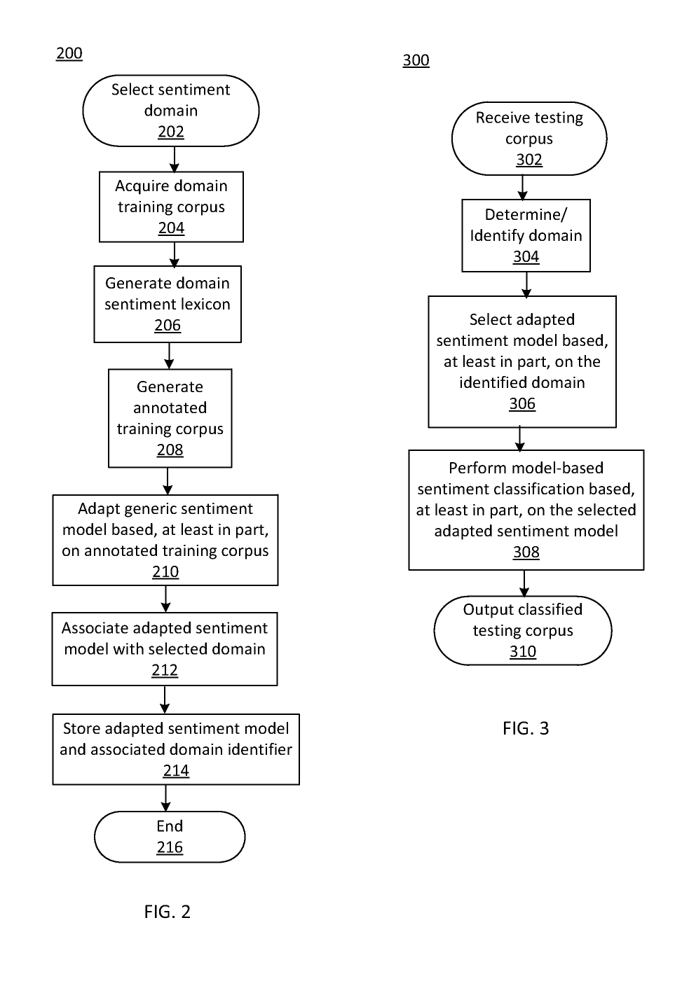

FIG. 2 is a flowchart 200 of adapted sentiment model generation operations according to various embodiments of the present disclosure. In particular, flowchart 200 illustrates unsupervisedly generating a domain-specific sentiment lexicon, unsupervisedly annotating a training corpus using the domain-specific sentiment lexicon and supervisedly adapting a generic sentiment model using the annotated training corpus. The operations may be performed, for example, by computing system 102, in particular, hybrid sentiment analyzer logic 124, including domain training corpus acquirer logic 126, sentiment lexicon generator logic 130, lexicon-based sentiment classifier logic 136 and model-based sentiment adaptor logic 142 of FIG. 1.

Operations of this embodiment may begin with selecting a sentiment domain at 202. A domain training corpus may be acquired at operation 204. For example, the domain may include a topical domain, a user domain and/or a group domain. The domain training corpus is related to the selected sentiment domain. A sentiment lexicon may be generated at operation 206. The sentiment lexicon may be generated unsupervisedly based, at least in part, on the acquired domain training corpus. An annotated training corpus may be generated at operation 208. The annotated training corpus may be generated unsupervisedly based, at least in part, on the generated sentiment lexicon. For example, the acquired domain training corpus may be searched for occurrences of sentiment terms included in the domain sentiment lexicon generated at operation 206. Whether a sentiment associated with a corpus element is positive, negative or neutral may then be determined based, at least in part, on its occurrence as a sentiment term in the domain sentiment lexicon generated at operation 206 and based, at least in part, on the sentiment polarity that is associated with this sentiment term in the domain sentiment lexicon.

In an embodiment, the annotated training corpus may be generated based, at least in part, on the acquired domain training corpus. In another embodiment, the annotated training corpus may be generated based, at least in part, on a training corpus that includes different corpus elements than those that were used to generate the sentiment lexicon. In both embodiments, the corpus elements may be related to the selected sentiment domain.

A generic sentiment model may be adapted based, at least in part, on the unsupervisedly annotated training corpus at operation 210. For example the generic sentiment model 144 of FIG. 1 may be adapted.

The adapted sentiment model may be associated with the selected domain at operation 212. The adapted sentiment model and an associated selected sentiment domain ID may be stored at operation 214. Program flow may end at operation 216. Thus, a domain-specific sentiment model may be generated based, at least in part, on unsupervised generation of a domain sentiment lexicon and associated unsupervisedly annotated training corpus and based, at least in part, on supervised adaptation of a generic sentiment model based, at least in part, on the unsupervisedly annotated training corpus.

Operations 204 through 214 may be repeated to update the adapted sentiment model. For example, the operations may be repeated to accommodate changing sentiments in the selected sentiment domain. In another example, the operations may be repeated to account for accumulated textual information related to the selected sentiment domain. Such updating may improve a quality of classifications of each domain testing corpus. Repetition of operations 202 through 216 may be triggered based, at least in part, on time (e.g., at a predefined time interval) and/or based, at least in part, on an amount of textual information accumulated since a prior generation of an adapted sentiment model, e.g., adapted sentiment model 146. Thus, the adapted sentiment model may be updated to reflect current sentiment.

FIG. 3 is a flowchart 300 of testing corpus classification operations using the adapted sentiment model of FIG. 2 according to various embodiments of the present disclosure. In particular, flowchart 300 illustrates supervised classification of a testing corpus using a domain-specific adapted sentiment model. The operations may be performed, for example, by computing system 102, in particular, hybrid sentiment analyzer logic 124 including model-based sentiment classifier logic 150 of FIG. 1.

Operations of this embodiment may begin with receiving a testing corpus 302. For example, the testing corpus may include textual information related to a specific domain. The sentiment domain may be determined and/or identified at operation 304. For example, the domain may correspond to a topical domain, a user domain and/or a group domain. An adapted sentiment model may be selected based, at least in part, on the identified domain at operation 306. Model-based sentiment classification may be performed based, at least in part, on the selected adapted sentiment model at operation 308. A classified testing corpus may be provided as output at operation 310. The classified testing corpus may include sentiment polari(ties) associated with corpus elements included in the testing corpus. For example, the classified testing corpus may be displayed on a computing system, e.g., computing system 102, for review by, e.g., a user. In another example, the classified testing corpus may be provided to a personal assistance application, e.g., personal assistance app 123.

Thus, a testing corpus may be supervisedly classified using a domain-specific adapted sentiment model. The domain-specific adapted sentiment model may be generated in a hybrid manner (i.e., including both supervised and unsupervised techniques) that avoids manual tagging of corpus elements while providing classification accuracy associated with supervised techniques.

While the flowcharts of FIGS. 2 and 3 illustrate operations according various embodiments, it is to be understood that not all of the operations depicted in FIGS. 2 and 3 are necessary for other embodiments. In addition, it is fully contemplated herein that in other embodiments of the present disclosure, the operations depicted in FIGS. 2 and/or 3, and/or other operations described herein may be combined in a manner not specifically shown in any of the drawings, and such embodiments may include less or more operations than are illustrated in FIGS. 2 and/or 3. Thus, claims directed to features and/or operations that are not exactly shown in one drawing are deemed within the scope and content of the present disclosure.

In a first usage example, it may be desired to determine an attitude (i.e., sentiment) of a person towards a product, a restaurant and/or a movie. In this example, product, restaurant and movie correspond to respective topical domains, for example, restaurant may correspond to a restaurant reviews topical domain. A respective adapted sentiment model may be generated for each topical domain according to a hybrid technique, as described herein. A testing corpus may be acquired that includes textual information from the person for one or more of the topical domains. A topical domain may be identified based, at least in part, on the textual information and a corresponding adapted sentiment model may be selected for each identified topical domain. Each testing corpus (and/or corpus element) and selected adapted sentiment model may then be provided to model-based sentiment classifier logic and the testing corpus (and/or corpus element) may then be classified. The sentiment of the person toward one or more topical domain(s) may thus be determined.

In a second usage example, it may be desired to analyze sentiments of consumers and/or users toward a newly released consumer electronics product. In this example, the consumers and/or users may be sharing their thoughts in an online forum, via, for example, an online social networking service and/or in a targeted survey. A domain training corpus may be acquired from, for example, reviews of existing consumer electronics products. A domain-specific sentiment lexicon may be generated and an annotated training corpus may be generated for the consumer electronics products domain, as described herein. The annotated training corpus may then be used to adapt a generic sentiment model to the consumer electronics product topical domain, as described herein. A domain testing corpus may then be generated based, at least in part, on textual information captured from the online forum, social networking service and/or targeted survey. The domain testing corpus may then be classified, as described herein, yielding the sentiment(s) of consumers and/or users toward the newly released consumer electronics product.

In a third usage example, it may be desired to perform user segmentation and targeting for providing selected recommendations to a user. In this example, the sentiment domain corresponds to a user domain and, thus, an adapted sentiment model may be generated for each user. A domain training corpus may be acquired for each user from textual information related to the respective user, i.e., textual information where the user is the source. Such textual information may include, for example, text messages, emails, etc. A user domain-specific sentiment lexicon may be generated and an annotated training corpus may be generated for each user, as described herein. Each annotated training corpus may then be used to adapt a generic sentiment model to the respective user domain to generate respective adapted generic sentiment models, as described herein.

A domain testing corpus may then correspond to textual information where a user is the source. The domain testing corpus may include textual information related to a topical domain. The domain testing corpus may then be classified, as described herein. The classification may then correspond to the user's sentiment associated with each corpus element in the domain testing corpus. In other words, the adapted sentiment model may then be related to sentiment terms used by a selected user. At least some sentiment terms may correspond to colloquialisms and/or jargon used by a specific user or group of users. Thus, the adapted sentiment model may be related to a specific user's personal way of using language. Detected sentiments may then be used for personal assistant applications. For example, the detected sentiments may be used to provide the user a personalized restaurant recommendation. In another example, the detected sentiments maybe used to target, e.g., advertising to the user. For example, the targeted advertising may be related to corpus elements associated with positive user sentiment.

Thus, methods and systems consistent with the present disclosure may be configured to generate a domain-specific sentiment lexicon and an annotated training corpus, unsupervisedly. The methods and systems are further configured to adapt a generic sentiment model using the annotated training corpus to provide a domain-specific adapted sentiment model.

OS 120 may be configured to manage system resources and control tasks that are run on each respective device and/or system, e.g., computing system 102. For example, the OS may be implemented using Microsoft Windows, HP-UX, Linux, or UNIX, although other operating systems may be used. In some embodiments, the OS may be replaced by a virtual machine monitor (or hypervisor) which may provide a layer of abstraction for underlying hardware to various operating systems (virtual machines) running on one or more processing units, i.e., core(s).

Memory 118 may include one or more of the following types of memory: semiconductor firmware memory, programmable memory, non-volatile memory, read only memory, electrically programmable memory, random access memory, flash memory, magnetic disk memory, and/or optical disk memory. Either additionally or alternatively system memory may include other and/or later-developed types of computer-readable memory.

Embodiments of the operations described herein may be implemented in a computer-readable storage device having stored thereon instructions that when executed by one or more processors perform the methods. The processor may include, for example, a processing unit and/or programmable circuitry. The storage device may include a machine readable storage device including any type of tangible, non-transitory storage device, for example, any type of disk including floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic and static RAMs, erasable programmable read-only memories (EPROMs), electrically erasable programmable read-only memories (EEPROMs), flash memories, magnetic or optical cards, or any type of storage devices suitable for storing electronic instructions.

As used in any embodiment herein, the term “logic” may refer to an app, software, firmware and/or circuitry configured to perform any of the aforementioned operations. Software may be embodied as a software package, code, instructions, instruction sets and/or data recorded on non-transitory computer readable storage medium. Firmware may be embodied as code, instructions or instruction sets and/or data that are hard-coded (e.g., nonvolatile) in memory devices.

“Circuitry”, as used in any embodiment herein, may comprise, for example, singly or in any combination, hardwired circuitry, programmable circuitry such as computer processors comprising one or more individual instruction processing cores, state machine circuitry, and/or firmware that stores instructions executed by programmable circuitry. The logic may, collectively or individually, be embodied as circuitry that forms part of a larger system, for example, an integrated circuit (IC), an application-specific integrated circuit (ASIC), a system on-chip (SoC), desktop computers, laptop computers, tablet computers, servers, smart phones, etc.

In some embodiments, a hardware description language (HDL) may be used to specify circuit and/or logic implementation(s) for the various logic and/or circuitry described herein. For example, in one embodiment the hardware description language may comply or be compatible with a very high speed integrated circuits (VHSIC) hardware description language (VHDL) that may enable semiconductor fabrication of one or more circuits and/or logic described herein. The VHDL may comply or be compatible with IEEE Standard 1076-1987, IEEE Standard 1076.2, IEEE1076.1, IEEE Draft 3.0 of VHDL-2006, IEEE Draft 4.0 of VHDL-2008 and/or other versions of the IEEE VHDL standards and/or other hardware description standards. Thus, consistent with the teachings of the present disclosure, a system and method include generating a domain-specific sentiment lexicon and an annotated training corpus, unsupervisedly. The methods and systems are further configured to adapt a generic sentiment model, supervisedly, using the annotated training corpus to provide a domain-specific adapted sentiment model.

### EXAMPLES

Examples of the present disclosure include subject material such as a method, means for performing acts of the method, a device, or of an apparatus or system related to a hybrid technique for sentiment analysis, as discussed below.

### Example 1

According to this example there is provided an apparatus. The apparatus includes a processor; at least one peripheral device coupled to the processor; a memory coupled to the processor; a generic sentiment model and a first domain training corpus stored in memory; and a hybrid sentiment analyzer logic stored in memory and to execute on the processor. The hybrid sentiment analyzer logic includes a sentiment lexicon generator logic to generate a domain sentiment lexicon based, at least in part, on the first domain training corpus and to store the domain sentiment lexicon in memory, a lexicon-based sentiment classifier logic to generate an annotated training corpus unsupervisedly, based, at least in part, on the domain sentiment lexicon and to store the annotated training corpus in memory, and a model-based sentiment adaptor logic to adapt the generic sentiment model based, at least in part, on the annotated training corpus to generate an adapted sentiment model and to store the adapted sentiment model in memory.

### Example 2

This example includes the elements of example 1, wherein the hybrid sentiment analyzer logic further includes a model-based sentiment classifier logic, the model-based sentiment classifier logic to classify a domain testing corpus based, at least in part, on the adapted sentiment model.

### Example 3

This example includes the elements of example 1, wherein the hybrid sentiment analyzer logic further includes a domain training corpus acquirer logic, the domain training corpus acquirer logic to acquire the first domain training corpus via at least one of the at least one peripheral device and to store the first domain training corpus in memory.

Example 4

This example includes the elements of example 2, wherein the model-based sentiment classifier logic is further to identify a domain.

### Example 5

This example includes the elements of example 4, wherein the model-based sentiment classifier logic is further to select the adapted sentiment model based, at least in part, on the identified domain.

### Example 6

This example includes the elements according to any one of examples 1 through 3, wherein the sentiment lexicon generator logic includes a dependency parser.

### Example 7

This example includes the elements according to any one of examples 1 through 3, wherein the hybrid sentiment analyzer logic is further to at least one of generate and/or acquire the generic sentiment model and to store the generic sentiment model in memory.

### Example 8

This example includes the elements according to any one of examples 1 through 3, further including an annotated generic corpus stored in memory wherein the model-based sentiment adaptor logic is to adapt the generic sentiment model based, at least in part, on the annotated generic corpus.

### Example 9

This example includes the elements according to any one of examples 1 through 3, wherein the hybrid sentiment analyzer logic is further to repeat generating the domain sentiment lexicon, generating the annotated training corpus and adapting the generic sentiment model at predefined time intervals.

### Example 10

This example includes the elements of example 3, wherein the hybrid sentiment analyzer logic is further to repeat generating the domain sentiment lexicon, generating the annotated training corpus and adapting the generic sentiment model based, at least in part, on an amount of corpus elements accumulated since a prior generating the domain sentiment lexicon, generating the annotated training corpus and adapting the generic sentiment model.

### Example 11

According to this example there is provided an apparatus. The apparatus includes a processor; at least one peripheral device; a memory; and hybrid sentiment analyzer logic. The hybrid sentiment analyzer logic is to: generate a domain sentiment lexicon based, at least in part, on a first domain training corpus, generate an annotated training corpus unsupervisedly, based, at least in part, on the domain sentiment lexicon, and adapt a generic sentiment model based, at least in part, on the annotated training corpus to generate an adapted sentiment model.

### Example 12

This example includes the elements of example 11, wherein the hybrid sentiment analyzer logic is further to classify a domain testing corpus based, at least in part, on the adapted sentiment model.

### Example 13

This example includes the elements of example 11, wherein the hybrid sentiment analyzer logic is further to acquire the first domain training corpus via at least one of the at least one peripheral device.

### Example 14

This example includes the elements of example 12, wherein the hybrid sentiment analyzer logic is further to identify a domain.

### Example 15

This example includes the elements of example 14, wherein the hybrid sentiment analyzer logic is further to select the adapted sentiment model based, at least in part, on the identified domain.

### Example 16

This example includes the elements according to any one of examples 11 through 13, wherein the hybrid sentiment analyzer logic includes a dependency parser.

### Example 17

This example includes the elements according to any one of examples 11 through 13, wherein the hybrid sentiment analyzer logic is further to at least one of generate and/or acquire the generic sentiment model.

### Example 18

This example includes the elements according to any one of examples 11 through 13, wherein the generic sentiment model is adapted based, at least in part, on an annotated generic corpus.

### Example 19

This example includes the elements according to any one of examples 11 through 13, wherein the hybrid sentiment analyzer logic is further to repeat generating the domain sentiment lexicon, generating the annotated training corpus and adapting the generic sentiment model at predefined time intervals.

### Example 20

This example includes the elements of example 13, wherein the hybrid sentiment analyzer logic is further to repeat generating the domain sentiment lexicon, generating the annotated training corpus and adapting the generic sentiment model based, at least in part, on an amount of corpus elements accumulated since a prior generating the domain sentiment lexicon, generating the annotated training corpus and adapting the generic sentiment model.

### Example 21

This example includes the elements of example 1 or 11, wherein the sentiment lexicon is generated unsupervisedly.

### Example 22

This example includes the elements example 1 or 11, wherein the generic sentiment model is adapted supervisedly.

### Example 23

This example includes the elements according to any one of examples 1 to 3 or 11 to 13, wherein first the domain training corpus includes one or more of a word, a phrase, a sentence and/or a document.

### Example 24

This example includes the elements according to any one of examples 1 to 3 or 11 to 13, wherein the first domain training corpus includes textual information.

### Example 25

This example includes the elements of example 24, wherein the textual information is related to at least one of an opinion and an attitude.

### Example 26

This example includes the elements according to any one of examples 1 to 3 or 11 to 13, wherein the sentiment lexicon includes at least one of a word and a phrase, annotated with a sentiment polarity.

### Example 27

This example includes the elements of example 26, wherein the sentiment polarity corresponds to positive, negative or neutral sentiment.

### Example 28

This example includes the elements according to any one of examples 1 to 3 or 11 to 13, wherein a domain associated with the first domain training corpus includes one or more of a topical domain, a user domain and a group domain.

### Example 29

This example includes the elements according to any one of examples 1 to 3 or 11 to 13, wherein the annotated training corpus corresponds to the first domain training corpus annotated with one or more sentiment polarit(ies).

### Example 30

This example includes the elements according to any one of examples 1 to 3 or 11 to 13, wherein the annotated training corpus includes a second domain training corpus annotated with one or more sentiment polarit(ies), the second domain training corpus different from the first domain training corpus.

### Example 31

This example includes the elements of example 7 or 17, wherein the generic sentiment model is generated using at least one of a support vector machine, an updatable Naïve Bayes model and/or an artificial neural network.

### Example 32

This example includes the elements according to any one of examples 1 to 3 or 11 to 13, wherein the adapted sentiment model is adapted using at least one of a support vector machine, an updatable Naïve Bayes model and/or an artificial neural network.

### Example 33

This example includes the elements of example 3 or 13, wherein the first domain training corpus is acquired from one or more of emails, text messages associated with social media, transcribed telephone conversations and/or consumer reviews.

### Example 34

This example includes the elements according to any one of examples 1 to 3 or 11 to 13, wherein the domain sentiment lexicon includes a plurality of sentiment terms.

### Example 35

According to this example, there is provided a method. The method includes generating, by a sentiment lexicon generator logic, a domain sentiment lexicon based, at least in part, on a first domain training corpus; generating, by a lexicon-based sentiment classifier logic, unsupervisedly, an annotated training corpus, based, at least in part, on the domain sentiment lexicon; and adapting, by a model-based sentiment adaptor logic, a generic sentiment model based, at least in part, on the annotated training corpus to generate an adapted sentiment model.

### Example 36

This example includes the elements of example 35, further including classifying, by a model-based sentiment classifier logic, a domain testing corpus based, at least in part, on the adapted sentiment model.

### Example 37

This example includes the elements of example 35, further including acquiring, by a domain training corpus acquirer logic, the first domain training corpus.

### Example 38

This example includes the elements of example 36, further including identifying, by the model-based sentiment classifier logic, a domain.

### Example 39

This example includes the elements of example 38, further including selecting, by the model-based sentiment classifier logic, the adapted sentiment model, based, at least in part on the identified domain.

### Example 40

This example includes the elements of example 35, wherein the sentiment lexicon generator logic includes a dependency parser .

### Example 41

This example includes the elements of example 35, further including at least one of generating and/or acquiring, by a hybrid sentiment analyzer logic, the generic sentiment model.

### Example 42

According to this example, there is provided a method. The method includes generating, by hybrid sentiment analyzer logic, a domain sentiment lexicon based, at least in part, on a first domain training corpus; generating, by the hybrid sentiment analyzer logic, unsupervisedly, an annotated training corpus, based, at least in part, on the domain sentiment lexicon; and adapting, by the hybrid sentiment analyzer logic, a generic sentiment model based, at least in part, on the annotated training corpus to generate an adapted sentiment model.

### Example 43

This example includes the elements of example 42, further including classifying, by the hybrid sentiment analyzer logic, a domain testing corpus based, at least in part, on the adapted sentiment model.

### Example 44

This example includes the elements of example 42, further including acquiring, by the hybrid sentiment analyzer logic, the first domain training corpus.

### Example 45

This example includes the elements of example 43, further including identifying, by the hybrid sentiment analyzer logic, a domain.

### Example 46

This example includes the elements of example 45, further including selecting, by the hybrid sentiment analyzer logic, the adapted sentiment model, based, at least in part on the identified domain.

### Example 47

This example includes the elements of example 42, wherein the hybrid sentiment analyzer logic includes a dependency parser.

### Example 48

This example includes the elements of example 42, further including at least one of generating and/or acquiring, by the hybrid sentiment analyzer logic, the generic sentiment model.

### Example 49

This example includes the elements of example 35 or 42, wherein the sentiment lexicon is generated unsupervisedly.

### Example 50

This example includes the elements of example 35 or 42, wherein the generic sentiment model is adapted supervisedly.

### Example 51

This example includes the elements of example 35 or 42, wherein first the domain training corpus includes one or more of a word, a phrase, a sentence and/or a document.

### Example 52

This example includes the elements of example 35 or 42, wherein the first domain training corpus includes textual information.

### Example 53

This example includes the elements of example 52, wherein the textual information is related to at least one of an opinion and an attitude.

### Example 54

This example includes the elements of example 35 or 42, wherein the sentiment lexicon includes at least one of a word and a phrase, annotated with a sentiment polarity.

### Example 55

This example includes the elements of example 54, wherein the sentiment polarity corresponds to positive, negative or neutral sentiment.

### Example 56

This example includes the elements of example 35 or 42, wherein a domain associated with the first domain training corpus includes one or more of a topical domain, a user domain and a group domain.

### Example 57

This example includes the elements of example 35 or 42, wherein the annotated training corpus corresponds to the first domain training corpus annotated with one or more sentiment polarit(ies).

### Example 58

This example includes the elements of example 35 or 42, wherein the annotated training corpus includes a second domain training corpus annotated with one or more sentiment polarit(ies), the second domain training corpus different from the first domain training corpus.

### Example 59

This example includes the elements of example 48, wherein the generic sentiment model is generated using at least one of a support vector machine, an updatable Naïve Bayes model and/or an artificial neural network.

### Example 60

This example includes the elements of example 35 or 42, wherein the generic sentiment model is adapted based, at least in part, on an annotated generic corpus.

### Example 61

This example includes the elements of example 35 or 42, wherein the adapted sentiment model is adapted using at least one of a support vector machine, an updatable Naïve Bayes model and/or an artificial neural network.

### Example 62

This example includes the elements of example 37 or 44, wherein the first domain training corpus is acquired from one or more of emails, test messages associated with social media, transcribed telephone conversations and/or consumer reviews.

### Example 63

This example includes the elements of example 35 or 42, wherein the domain sentiment lexicon includes a plurality of sentiment terms.

### Example 64

This example includes the elements of example 35 or 42, further including repeating the generating the domain sentiment lexicon, generating the annotated training corpus and adapting the generic sentiment model at predefined time intervals.

### Example 65

This example includes the elements of example 37 or 44, further including repeating the generating the domain sentiment lexicon, generating the annotated training corpus and adapting the generic sentiment model based, at least in part, on an amount of corpus elements accumulated since a prior generating the domain sentiment lexicon, generating the annotated training corpus and adapting the generic sentiment model.

### Example 66

According to this example there is a computer readable storage device having stored thereon instructions that when executed by one or more processors result in the following operations including generating a domain sentiment lexicon based, at least in part, on a first domain training corpus; generating an annotated training corpus unsupervisedly, based, at least in part, on the domain sentiment lexicon; and adapting a generic sentiment model based, at least in part, on the annotated training corpus to generate an adapted sentiment model.

### Example 67

This example includes the elements of example 66, wherein the sentiment lexicon is generated unsupervisedly.

### Example 68

This example includes the elements of example 66, wherein the generic sentiment model is adapted supervisedly.

### Example 69

This example includes the elements of example 66, wherein the instructions that when executed by one or more processors results in the following additional operations including classifying a domain testing corpus based, at least in part, on the adapted sentiment model.

### Example 70

This example includes the elements of example 66, wherein the instructions that when executed by one or more processors results in the following additional operations including acquiring the first domain training corpus.

### Example 71

This example includes the elements of example 69, wherein the instructions that when executed by one or more processors results in the following additional operations including identifying a domain.

### Example 72

This example includes the elements of example 71, wherein the instructions that when executed by one or more processors results in the following additional operations including selecting the adapted sentiment model, based, at least in part on the identified domain.

### Example 73

This example includes the elements according to any one of examples 66 through 70, wherein first the domain training corpus includes one or more of a word, a phrase, a sentence and/or a document.

### Example 74

This example includes the elements according to any one of examples 66 through 70, wherein the first domain training corpus includes textual information.

### Example 75

This example includes the elements of example 74, wherein the textual information is related to at least one of an opinion and an attitude.

### Example 76

This example includes the elements according to any one of examples 66 through 70, wherein the sentiment lexicon includes at least one of a word and a phrase, annotated with a sentiment polarity.

### Example 77

This example includes the elements of example 76, wherein the sentiment polarity corresponds to positive, negative or neutral sentiment.

### Example 78

This example includes the elements according to any one of examples 66 through 70, wherein a domain associated with the first domain training corpus includes one or more of a topical domain, a user domain and a group domain.

### Example 79

This example includes the elements according to any one of examples66 through 70, wherein the instructions include a dependency parser.

### Example 80

This example includes the elements according to any one of examples 66 through 70, wherein the annotated training corpus corresponds to the first domain training corpus annotated with one or more sentiment polarit(ies).

### Example 81

This example includes the elements according to any one of examples 66 through 70, wherein the annotated training corpus includes a second domain training corpus annotated with one or more sentiment polarit(ies), the second domain training corpus different from the first domain training corpus.

### Example 82

This example includes the elements according to any one of examples 66 through 70, wherein the instructions that when executed by one or more processors results in the following additional operations including at least one of generating and/or acquiring the generic sentiment model.

### Example 83

This example includes the elements of example 82, wherein the generic sentiment model is generated using at least one of a support vector machine, an updatable Naïve Bayes model and/or an artificial neural network.

### Example 84

This example includes the elements according to any one of examples 66 through 70, wherein the generic sentiment model is adapted based, at least in part, on an annotated generic corpus.

### Example 85

This example includes the elements according to any one of examples 66 through 70, wherein the adapted sentiment model is adapted using at least one of a support vector machine, an updatable Naïve Bayes model and/or an artificial neural network.

### Example 86

This example includes the elements of example 70, wherein the first domain training corpus is acquired from one or more of emails, text messages associated with social media, transcribed telephone conversations and/or consumer reviews.

### Example 87

This example includes the elements according to any one of examples 66 through 70, wherein the domain sentiment lexicon includes a plurality of sentiment terms.

### Example 88

This example includes the elements according to any one of examples 66 through 70, wherein the instructions that when executed by one or more processors results in the following additional operations including repeating generating the domain sentiment lexicon, generating the annotated training corpus and adapting the generic sentiment model at predefined time intervals.

### Example 89

This example includes the elements of example 70, wherein the instructions that when executed by one or more processors results in the following additional operations including repeating generating the domain sentiment lexicon, generating the annotated training corpus and adapting the generic sentiment model based, at least in part, on an amount of corpus elements accumulated since a prior generating the domain sentiment lexicon, generating the annotated training corpus and adapting the generic sentiment model.

### Example 90

According to this example there is provided an apparatus. The apparatus includes means for generating, by a sentiment lexicon generator logic, a domain sentiment lexicon based, at least in part, on a first domain training corpus; means for generating, by a lexicon-based sentiment classifier logic, unsupervisedly, an annotated training corpus, based, at least in part, on the domain sentiment lexicon; and means for adapting, by a model-based sentiment adaptor logic, a generic sentiment model based, at least in part, on the annotated training corpus to generate an adapted sentiment model.

### Example 91

This example includes the elements of example 90, further including means for classifying, by a model-based sentiment classifier logic, a domain testing corpus based, at least in part, on the adapted sentiment model.

### Example 92

This example includes the elements of example 90, further including means for acquiring, by a domain training corpus acquirer logic, the first domain training corpus.

### Example 93

This example includes the elements of example 91, further including means for identifying, by the model-based sentiment classifier logic, a domain.

### Example 94

This example includes the elements of example 93, further including means for selecting, by the model-based sentiment classifier logic, the adapted sentiment model, based, at least in part on the identified domain.

### Example 95

This example includes the elements of example 90, wherein the sentiment lexicon generator logic includes a dependency parser.

### Example 96

This example includes the elements of example 90, further including means for at least one of generating and/or acquiring, by a hybrid sentiment analyzer logic, the generic sentiment model.

### Example 97

According to this example there is provided an apparatus. The apparatus includes means for generating, by hybrid sentiment analyzer logic, a domain sentiment lexicon based, at least in part, on a first domain training corpus; means for generating, by the hybrid sentiment analyzer logic, unsupervisedly, an annotated training corpus, based, at least in part, on the domain sentiment lexicon; and means for adapting, by the hybrid sentiment analyzer logic, a generic sentiment model based, at least in part, on the annotated training corpus to generate an adapted sentiment model.

### Example 98

This example includes the elements of example 97, further including means for classifying, by the hybrid sentiment analyzer logic, a domain testing corpus based, at least in part, on the adapted sentiment model.

### Example 99

This example includes the elements of example 97, further including means for acquiring, by the hybrid sentiment analyzer logic, the first domain training corpus.

### Example 100

This example includes the elements of example 98, further including means for identifying, by the hybrid sentiment analyzer logic, a domain.

Example 101

This example includes the elements of example 100, further including means for selecting, by the hybrid sentiment analyzer logic, the adapted sentiment model, based, at least in part on the identified domain.

### Example 102

This example includes the elements of example 97, wherein the hybrid sentiment analyzer logic includes a dependency parser.

### Example 103

This example includes the elements of example 97, further including means for at least one of generating and/or acquiring, by the hybrid sentiment analyzer logic, the generic sentiment model.

### Example 104

This example includes the elements of example 90 or 97, wherein the sentiment lexicon is generated unsupervisedly.

### Example 105

This example includes the elements of example 90 or 97, wherein the generic sentiment model is adapted supervisedly.

### Example 106

This example includes the elements of example 90 or 97, wherein first the domain training corpus includes one or more of a word, a phrase, a sentence and/or a document.

### Example 107

This example includes the elements of example 90 or 97, wherein the first domain training corpus includes textual information.

### Example 108

This example includes the elements of example 107, wherein the textual information is related to at least one of an opinion and an attitude.

### Example 109

This example includes the elements of example 90 or 97, wherein the sentiment lexicon includes at least one of a word and a phrase, annotated with a sentiment polarity.

### Example 110

This example includes the elements of example 109, wherein the sentiment polarity corresponds to positive, negative or neutral sentiment.

### Example 111

This example includes the elements of example 90 or 97, wherein a domain associated with the first domain training corpus includes one or more of a topical domain, a user domain and a group domain.

### Example 112

This example includes the elements of example 90 or 97, wherein the annotated training corpus includes a second domain training corpus annotated with one or more sentiment polarit(ies), the second domain training corpus different from the first domain training corpus.

### Example 113

This example includes the elements of example 90 or 97, wherein the annotated training corpus includes a second domain training corpus annotated with one or more sentiment polarit(ies), the second domain training corpus different from the first domain training corpus.

### Example 114

This example includes the elements of example 96 or 103, wherein the generic sentiment model is generated using at least one of a support vector machine, an updatable Naïve Bayes model and/or an artificial neural network.

### Example 115

This example includes the elements of example 90 or 97, wherein the generic sentiment model is adapted based, at least in part, on an annotated generic corpus.

### Example 116

This example includes the elements of example 90 or 97, wherein the adapted sentiment model is adapted using at least one of a support vector machine, an updatable Naïve Bayes model and/or an artificial neural network.

### Example 117

This example includes the elements of example 92 or 99, wherein the first domain training corpus is acquired from one or more of emails, test messages associated with social media, transcribed telephone conversations and/or consumer reviews.

### Example 118

This example includes the elements of example 90 or 97, wherein the domain sentiment lexicon includes a plurality of sentiment terms.

### Example 119

This example includes the elements of example 90 or 97, further including means for repeating the generating the domain sentiment lexicon, generating the annotated training corpus and adapting the generic sentiment model at predefined time intervals.

### Example 120

This example includes the elements of example 90 or 97, further including means for repeating the generating the domain sentiment lexicon, generating the annotated training corpus and adapting the generic sentiment model based, at least in part, on an amount of corpus elements accumulated since a prior generating the domain sentiment lexicon, generating the annotated training corpus and adapting the generic sentiment model.

### Example 121

According to this example there is a computer readable storage device having stored thereon instructions that when executed by one or more processors result in the following operations including the method according to any one of examples 35 through 65.

### Example 122

Another example of the present disclosure is a system including at least one device arranged to perform the method of any one of examples 35 through 65.

### Example 123

Another example of the present disclosure is a device including means to perform the method of any one of examples 35 through 65.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents.

Various features, aspects, and embodiments have been described herein. The features, aspects, and embodiments are susceptible to combination with one another as well as to variation and modification, as will be understood by those having skill in the art. The present disclosure should, therefore, be considered to encompass such combinations, variations, and modifications.

What is claimed is:

1. An apparatus comprising:
a processor;
at least one peripheral device coupled to the processor;
a memory coupled to the processor;
a generic sentiment model and a first domain training corpus stored in memory; and
a hybrid sentiment analyzer logic stored in memory and to execute on the processor, the hybrid sentiment analyzer logic comprising:
a sentiment lexicon generator logic to generate a domain sentiment lexicon based, at least in part, on the first domain training corpus and to store the domain sentiment lexicon in memory,
a lexicon-based sentiment classifier logic to generate an annotated training corpus unsupervisedly, based, at least in part, on the domain sentiment lexicon and to store the annotated training corpus in memory, and
a model-based sentiment adaptor logic to adapt the generic sentiment model based, at least in part, on the annotated training corpus to generate an adapted sentiment model and to store the adapted sentiment model in memory.

2. The apparatus of claim 1, wherein the hybrid sentiment analyzer logic further comprises a model-based sentiment classifier logic, the model-based sentiment classifier logic to classify a domain testing corpus based, at least in part, on the adapted sentiment model.

3. The apparatus of claim 1, wherein the hybrid sentiment analyzer logic further comprises a domain training corpus acquirer logic, the domain training corpus acquirer logic to acquire the first domain training corpus via at least one of the at least one peripheral device and to store the first domain training corpus in memory.

4. The apparatus of claim 1, wherein the hybrid sentiment analyzer logic is further to at least one of generate and/or acquire the generic sentiment model and to store the generic sentiment model in memory.

5. The apparatus of claim 1, wherein the sentiment lexicon is generated unsupervisedly.

6. The apparatus of claim 1, wherein the generic sentiment model is adapted supervisedly.

7. The apparatus of claim 1, wherein a domain associated with the first domain training corpus comprises one or more of a topical domain, a user domain and a group domain

8. The apparatus of claim 1, wherein the adapted sentiment model is adapted using at least one of a support vector machine, an updatable Naïve Bayes model and/or an artificial neural network.

9. A method comprising:
generating, by a sentiment lexicon generator logic, a domain sentiment lexicon based, at least in part, on a first domain training corpus;
generating, by a lexicon-based sentiment classifier logic, unsupervisedly, an annotated training corpus, based, at least in part, on the domain sentiment lexicon; and
adapting, by a model-based sentiment adaptor logic, a generic sentiment model based, at least in part, on the annotated training corpus to generate an adapted sentiment model.

10. The method of claim 9, further comprising classifying, by a model-based sentiment classifier logic, a domain testing corpus based, at least in part, on the adapted sentiment model.

11. The method of claim 9, further comprising acquiring, by a domain training corpus acquirer logic, the first domain training corpus.

12. The method of claim 9, further comprising at least one of generating and/or acquiring, by a hybrid sentiment analyzer logic, the generic sentiment model.

13. The method of claim 9, wherein the sentiment lexicon is generated unsupervisedly.

14. The method of claim 9, wherein the generic sentiment model is adapted supervisedly.

15. The method of claim 9, wherein a domain associated with the first domain training corpus comprises one or more of a topical domain, a user domain and a group domain.

16. The method of claim 9, wherein the adapted sentiment model is adapted using at least one of a support vector machine, an updatable Naïve Bayes model and/or an artificial neural network.

17. A computer readable storage device having stored thereon instructions that when executed by one or more processors result in the following operations comprising:
generating a domain sentiment lexicon based, at least in part, on a first domain training corpus;
generating an annotated training corpus unsupervisedly, based, at least in part, on the domain sentiment lexicon; and
adapting a generic sentiment model based, at least in part, on the annotated training corpus to generate an adapted sentiment model.

18. The device of claim 17, wherein the sentiment lexicon is generated unsupervisedly.

19. The device of claim 17, wherein the generic sentiment model is adapted supervisedly.

20. The device of claim 17, wherein the instructions that when executed by one or more processors results in the following additional operations comprising classifying a domain testing corpus based, at least in part, on the adapted sentiment model.

21. The device of claim 17, wherein the instructions that when executed by one or more processors results in the following additional operations comprising acquiring the first domain training corpus.

22. The device of claim 17, wherein a domain associated with the first domain training corpus comprises one or more of a topical domain, a user domain and a group domain.

23. The device of claim 17, wherein the instructions that when executed by one or more processors results in the following additional operations comprising at least one of generating and/or acquiring the generic sentiment model.

24. The device of claim 17, wherein the adapted sentiment model is adapted using at least one of a support vector machine, an updatable Naïve Bayes model and/or an artificial neural network.
